(19) United States
(12) Patent Application Publication
(10) Pub. No.: US 2026/0021707 A1
(43) Pub. Date: Jan. 22, 2026

(54) SAFETY SYSTEM FOR AN ELECTRICALLY DRIVEABLE MOTOR VEHICLE, MOTOR VEHICLE AND METHOD FOR OPERATING A SAFETY SYSTEM

(71) Applicants: VOLKSWAGEN AKTIENGESELLSCHAFT, Wolfsburg (DE); MAN ENERGY SOLUTIONS SE INTELLECTUAL PROPERTY (PM), Augsburg (DE)

(72) Inventors: Hauke Christian Schlimme, Wolfsburg (DE); Frank Bärecke, Wolfsburg (DE); Arne Bartels, Wolfsburg (DE); Benjamin Just, Magdeburg (DE)

(21) Appl. No.: 18/998,057

(22) PCT Filed: May 31, 2023
(86) PCT No.: PCT/EP2023/064514

§ 371 Date: Jan. 23, 2025

(30) Foreign Application Priority Data
Jul. 25, 2022 (DE) 102022207552.8

(51) Int. Cl. B60L 7/26; B60L 3/00; B60L 7/22

(52) U.S. Cl. CPC B60L 7/26; B60L 3/0076; B60L 7/22; B60L 2240/12; B60L 2240/46; B60L 2240/54; B60L 2240/642

(57) ABSTRACT

A safety system for an electrically drivable motor vehicle includes a primary braking system, a secondary braking system, and a tertiary braking system. The system includes a monitoring device configured to detect an operating error in the primary and/or secondary braking systems, a detection unit configured to acquire motor vehicle data, and an evaluation unit configured to assess an achievable deceleration potential of the tertiary braking system using the motor vehicle data. A comparison unit compares the evaluated deceleration potential to at least one defined safety criterion, and a control unit controls the motor vehicle based on the detection of an operating error and/or the comparison result. Also described are methods for operating the safety system, including recognizing an operating error, acquiring motor vehicle data, evaluating the deceleration potential, comparing the deceleration potential to a safety criterion, and controlling the motor vehicle based on these steps.

### RELATED APPLICATIONS

The present application claims priority to International Patent Application No. PCT/EP2023/064514 to Schlimme, et al. filed May 31, 2023, titled “Safety System For An Electrically Driveable Motor Vehicle, Motor Vehicle And Method For Operating A Safety System,” which claims priority to German Patent Application No. 10 2022 207 552.8, filed Jul. 25, 2022, the contents of each being incorporated by reference in their entirety herein.

### TECHNICAL FIELD

The present disclosure, in general, relates to the field of at least semi-electrically operated motor vehicles and to the field of brake-by-wire braking systems and conventional, coupled braking systems. Specifically, the present disclosure relates to a safety system for an electrically drivable motor vehicle, to a motor vehicle comprising such a safety system, and to a method for operating such a safety system.

### BACKGROUND

In the automotive industry, the brake-by-wire technology refers to the option of controlling the brakes using electrical means. It may be designed to supplement regular. mechanically coupled service brakes or as a dedicated braking system.

In brake-by-wire braking systems, the braking force can be built by way of a hydraulic pressure build-up, for example by way of a pump. Such braking systems can be referred to as electrohydraulic braking systems. As an alternative, conventional components, such as pumps, hoses, liquids, belts as well as the master cylinder, can be replaced by electronic sensors and actuators in the brake-by-wire braking systems. Such braking systems can be referred to as electromechanical braking systems.

The use of brake-by-wire braking systems instead of conventional coupled braking systems, however, is associated with a clear drawback. It is required to have a fallback level, stipulated by law, so that the brakes can still be actuated in the event of a failure of the electronic system. In some cases, even a second fallback level becomes necessary to ensure the safety of the motor vehicle passengers.

In electrohydraulic brakes, an additional valve, which is opened in the de-energized state thereof, can be provided as a fallback level. In this way, the coupling between the brake pedal and a hydraulic circuit can be re-established.

In electromechanical brakes, an additional energy storage device can form the fallback level, thereby providing redundancy in the signal conduction. The presence of an additional or second energy storage device represents a considerable difference in weight, installation space, and cost.

### SUMMARY

Aspects of the present disclosure are directed to at least partially eliminating the above-described disadvantages. In particular, aspects of the present disclosure are directed to increasing the safety of passengers of a motor vehicle as well as of other road users.

Some aspects are disclosed in the independent claims of the present application, detailed below. Additional aspects are disclosed in the dependent claims, the description and the drawings. It should be understood by those skilled in the art that features and details that are described in connection with the safety system according to the present disclosure also apply in connection with the vehicle, the method, the computer program product and/or the computer-readable medium, and vice versa, so that mutual reference is always made, or can be made, to the individual aspects of the invention with respect to the disclosure.

In the various examples described herein, an improved safety system can be provided. The safety of the motor vehicle passengers as well as of road users can be increased by way of such a safety system.

In some examples, a safety system is disclosed for an electrically drivable motor vehicle. The safety system comprises a primary braking system, a secondary braking system, and a tertiary braking system. The safety system moreover comprises a monitoring device for recognizing an operating error in the primary braking system and/or in the secondary braking system. The safety system furthermore comprises a detection unit for detecting motor vehicle data, and an evaluation unit designed to evaluate an achievable deceleration potential of the tertiary braking system of the motor vehicle using motor vehicle data. The safety system furthermore comprises a comparison unit for comparing the evaluated deceleration potential of the tertiary braking system of the motor vehicle to at least one defined safety criterion, and a control unit designed to control the electrically drivable motor vehicle based on the recognition of an operating error and/or on the comparison between the evaluated deceleration potential and the defined safety criterion.

In some examples, a motor vehicle is disclosed. The motor vehicle comprises a safety system, which has a data communication connection to the motor vehicle and is configured as described herein.

In this way, a motor vehicle having a reliable braking behavior can be provided.

In some examples, a method is disclosed for operating a safety system comprising: recognizing an operating error of the primary braking system by a monitoring device of the safety system; detecting motor vehicle data, in particular motor vehicle data including driving surroundings information and/or motor vehicle state information, by a detection unit of the safety system; evaluating an achievable deceleration potential of the tertiary braking system of the motor vehicle, using motor vehicle data, by an evaluation unit of the safety system; comparing the evaluated deceleration potential to a safety criterion by a comparison unit of the safety system; and controlling the electrically drivable motor vehicle, in particular the secondary braking system and/or of the tertiary braking system, the control including a triggering of a first safety measure.

An improved and reliable operation of a safety system can advantageously be provided by way of embodiments of such a method. The safety of the motor vehicle passengers as well as of the road users can be increased by way of such a method as well.

In some examples, the method may further comprise: recognizing an operating error of the secondary braking system; and controlling the tertiary braking system, the control of the tertiary braking system including a triggering of a second safety measure.

In some examples, the first safety measure of the method, as described above and below, may include a deceleration of the motor vehicle. As an alternative or in addition, the second safety measure of the method, as described above and below, comprises a full deceleration of the motor vehicle.

Other or additional safety measures that bring about an intervention in the driving behavior of the motor vehicle are likewise conceivable.

The reliability of the braking power of the motor vehicle is thus further increased. As a result, the safety of the motor vehicle passengers and of the road users can be increased.

In some examples, a computer program product is disclosed, encompassing commands that, during execution by a processing unit, prompt the processing unit to carry out a method, as described above and below.

It should be noted that the processing unit can be assigned to both the safety system and the motor vehicle.

In some examples, a computer-readable medium is disclosed on which the computer program product, as described above, is stored.

Any disclosure described above and hereafter with respect to one aspect of the present disclosure applies similarly to all other aspects of the present disclosure.

### BRIEF DESCRIPTION OF THE DRAWINGS

Aspects of the present disclosure will be described hereafter with reference to the figures.

FIG. 1 schematically shows a safety system according to some aspects of the present disclosure;

FIG. 2 schematically shows an exemplary progression of an operating strategy of a motor vehicle according to some aspects of the present disclosure;

FIG. 3 schematically shows an exemplary assessment of the deceleration potential, according to some aspects of the present disclosure; and

FIG. 4 shows a flow chart of a method according to some aspects of the present disclosure.

### DETAILED DESCRIPTION

Similar, similarly acting, identical or like-acting elements are denoted by similar or identical reference numerals in the figures. The figures are only schematic representations and are not true to scale.

In various examples and configurations disclosed herein, a safety system is described, comprising three braking systems, wherein the secondary braking system may serve as a first fallback level, and the tertiary braking system may serve as a second fallback level. A potential operating error, as used herein, may be recognized via a monitoring device, which may detect disturbances in the primary, secondary, and/or tertiary braking systems. For example, if an operating error in the primary braking system is detected, the secondary braking system may be utilized. Similarly, if an operating error occurs in the secondary braking system, the tertiary braking system may be employed. The primary braking system may be a brake-by-wire braking system. The secondary braking system may also be configured as a brake-by-wire braking system or alternatively as a conventional hydraulic braking system. Additionally, it is contemplated that the primary and/or secondary braking systems may operate as a coupled braking system.

The motor vehicle may be a hybrid vehicle or an electric vehicle. In general, the context of the present disclosure involves a motor vehicle that may be at least partly powered by electrical energy and, for this purpose, is equipped with a battery.

It should be noted that the terms “primary braking system,” “secondary braking system,” and “tertiary braking system,” as used herein, do not indicate a fixed prioritization among the braking systems. These terms are used to differentiate between braking systems and may denote a prioritized sequence during normal operation, i.e., operation without an error. For instance, the primary braking system may ensure braking action during normal operation. During a first fallback operation, the secondary braking system may ensure braking action. Thus, if the secondary braking system experiences a fault, the primary braking system may subsequently be reassigned as the secondary braking system.

Furthermore, during normal operation, the primary, secondary, and tertiary braking systems may collectively generate the braking action. During fallback operation, for example, after the occurrence of a first operating error, the secondary and tertiary braking systems may collectively generate the braking action. This joint operation, particularly during normal conditions, may be desirable for maximizing regenerative energy recovery and operating the motor vehicle with improved energy efficiency.

The term “operating error.” as used herein, is broadly defined and may include malfunctions in the electronic components of a braking system and/or abnormal behavior of the mechanical components of the system. For example, an operating error in the primary braking system may be referred to as a first fault, while an operating error in the secondary braking system may be referred to as a second fault.

The safety system may include an evaluation unit configured to assess the achievable deceleration potential of the tertiary braking system. For instance, if the primary braking system becomes inoperable due to an operating error, the motor vehicle may transition to a state in which only the tertiary braking system provides a fallback mechanism. In such scenarios, the tertiary braking system may ensure braking power or bring the motor vehicle to a halt as safely as possible. To enhance passenger safety, it may be advantageous to evaluate or estimate the deceleration potential achievable by the tertiary braking system. This evaluation may allow for determining a maximum stopping distance or another safety-related parameter that the tertiary braking system can achieve. Such evaluations may be carried out by the evaluation unit upon recognizing an operating error in the primary braking system.

The term “motor vehicle passengers,” as used herein, refers to any persons or animals present in the motor vehicle.

The term “deceleration potential.” as used herein, refers to parameters such as the braking distance or stopping distance achievable by the motor vehicle. These parameters may reflect the ability of the braking system to bring the vehicle to a complete stop under current and/or anticipated conditions. Deceleration potential may also include factors such as braking time, average deceleration levels, collision probabilities during fallback operation, or error rates.

The deceleration potential may depend on various factors, including motor vehicle data. Accordingly, the safety system may include a detection unit configured to acquire motor vehicle data, such as vehicle mass, speed, and tire temperature. Based on this data, the evaluation unit may assess the deceleration potential achievable by the tertiary braking system in scenarios involving an operating error in the secondary braking system.

The tertiary braking system may interact with an electric machine (e-machine) of the motor vehicle, thereby influencing its deceleration potential. For instance, the deceleration potential of the tertiary braking system may depend on factors such as battery temperature or state of charge (SoC). The motor vehicle data may, therefore, include information about the battery and the electric machine.

The comparison unit of the safety system may compare the evaluated deceleration potential of the tertiary braking system to predefined safety criteria. For example, the comparison unit may determine whether the achievable deceleration potential satisfies passenger safety requirements. The term “safety criterion,” as used herein, may include operational strategies for the motor vehicle, such as conditions requiring the vehicle to be brought to a halt or restrictions on maximum allowable speeds.

Based on the recognition of an operating error and/or the comparison of deceleration potential against safety criteria, a control unit may manage the motor vehicle's operation. For example, if the safety criteria are satisfied, no intervention may be necessary. Conversely, if the criteria are not satisfied, the control unit may intervene in the vehicle's operation, such as by controlling braking systems or limiting driving power to ensure compliance with safety requirements.

For instance, the control unit may manage the secondary or tertiary braking systems in response to operating errors. If an error occurs in the secondary braking system, the tertiary braking system may be activated to bring the vehicle to a halt. The control unit may also account for factors such as driving surroundings or motor vehicle state information, including road grade, outside temperature, wind conditions, and ground quality, among others.

In some configurations, the tertiary braking system may be configured as an electric motor braking system, enabling energy generated during braking to be converted into electrical energy for storage in the vehicle's battery. The availability of the energy storage device may influence the operation of the tertiary braking system and its achievable deceleration potential.

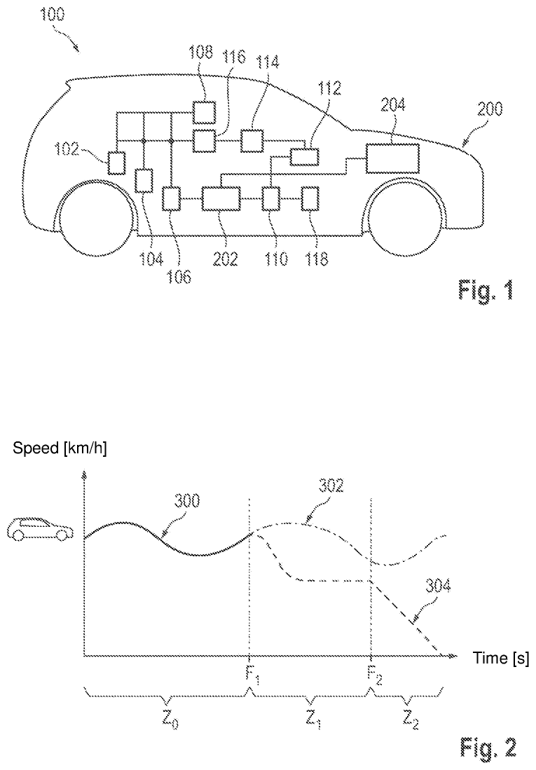

FIG. 1 shows a safety system 100 according to one exemplary embodiment. The safety system 100 comprises three braking systems: a primary braking system 102, a secondary braking system 104, and a tertiary braking system 106. The safety system 100 of

FIG. 1 furthermore comprises a monitoring device 108, a detection unit 110, an evaluation unit 112, a comparison unit 114, and a control unit 116. The monitoring device 108 can recognize and possibly report an operating error, that is, a disturbance or abnormal behavior in all three braking systems. Motor vehicle data can be detected and possibly received via the detection unit 110. This motor vehicle data can be used by the evaluation unit 112 to evaluate the achievable deceleration potential of the tertiary braking system 106. The tertiary braking system 106 can function as either an electric motor or a generator. In general, it should be noted that an electric machine can operate in both “motor” and “generator” modes. Deceleration of the vehicle can be achieved by operating as a generator. However, it must be possible to switch to motor operation in the low-speed range due to the electric machine's characteristic map, enabling deceleration down to a standstill. The braking power of the tertiary braking system 106 can thus depend, for example, on the state of charge of the battery 202 (also referred to as energy storage device 202) of the motor vehicle 200, as well as the battery 202's temperature. The battery 202 can be electrically connected to both the tertiary braking system 106 and the motor vehicle drive 204. The faster and more efficiently the battery 202 of the motor vehicle 200 can receive electrical energy, the more effective the tertiary braking system 106 will be.

The evaluation unit 112 can assess the achievable deceleration potential of the tertiary braking system 106 using the motor vehicle data after an operating error, or any disturbance, has been recognized in the primary braking system 102 by the monitoring device 108. Once an operating error has been detected in the primary braking system 102, that is, a first fault, the secondary braking system 104 can be used for the deceleration of the vehicle. However, if an operating error occurs in the secondary braking system 104, the tertiary braking system 106 is responsible for decelerating the motor vehicle 200. When a second fault is recognized, the motor vehicle 200 is controlled by the control unit 116 to achieve full deceleration. Consequently, if an operating error occurs in the secondary braking system 104, it must be ensured that the tertiary braking system 106 can achieve the necessary deceleration to bring the motor vehicle 200 to a halt in accordance with a defined safety criterion. If the comparison unit 114 establishes at the occurrence of a first fault that the safety criterion cannot be satisfied, the control unit 116 can control the motor vehicle 200 in such a way that the safety criterion is met after the driving behavior 300 of the motor vehicle 200 has been adapted.

In other words, the deceleration potential of the tertiary braking system 106 can be assessed by the evaluation unit 112 to estimate the performance capability of the second fallback level. The motor vehicle 200 can be prepared for a potential second fault, allowing the control unit 116 to manage the motor vehicle accordingly.

Furthermore, it is conceivable that as soon as a first fault is detected in the primary braking system 102, the vehicle 200 is controlled in a manner that increases the performance capability of the tertiary braking system 106, without limiting the driving options of the motor vehicle 200. This process could be referred to as conditioning the motor vehicle 200, preparing it for a potential second fault.

FIG. 2 shows an exemplary progression of an operating strategy of a motor vehicle 200 according to one embodiment. This motor vehicle 200 comprises a safety system 100, such as the safety system 100 of FIG. 1. The speed of the motor vehicle 200 in [km/h] is shown on the vertical axis (the y-axis), while the time in seconds [s] is shown on the horizontal axis (the x-axis). The curve denoted by reference numeral 300 represents a possible progression of the speed over time during which no operating error is recognized by the monitoring device 108, that is, during normal operation Z0. The curve 300 thus illustrates driving behavior. A first fault F1, which is an operating error in the primary braking system 102, can be recognized, causing the motor vehicle 200 to transition into the operating status of the first fallback level Z1. In preparation for a potential second fault F2, the evaluation unit 112 can assess the achievable deceleration potential of the tertiary braking system 106. For this purpose, motor vehicle data are detected and/or received by the detection unit 110. This data can be gathered via an interface 118, such as a radio interface. Based on this information. the deceleration potential of the tertiary braking system 106 can be estimated or evaluated. Specifically, the evaluation unit 112 can calculate and/or forecast an estimated stopping distance of the motor vehicle using the tertiary braking system 106. An achievable deceleration potential can be, for example, χ₁m, χ₂m or χ₃m. Based on a comparison between the evaluated deceleration potential and a defined safety criterion, the control unit 116 can accordingly control the motor vehicle 200. In other words, the control unit 116 can take one or more safety measures so as to ensure the safety of the motor vehicle passengers.

The curve 302 of FIG. 2 shows an exemplary progression of the speed of the motor vehicle 200 in which a first fault has occurred, while the safety criterion is still satisfied. The curve 302 can thus represent an undisturbed driving behavior. As a result, no intervention in the driving behavior of the motor vehicle 200 is required by the control unit 116. A second fault F2 does not occur in the exemplary progression of the curve 302.

The curve 304 shows a progression in which the control unit 116 has already had to take a safety measure after the first fault F1. The curve 304 can therefore represent a controlled driving behavior. In this case, the motor vehicle 200 is decelerated until a maximum permitted speed is reached. The safety measure performed by the control unit 116 may involve decelerating the motor vehicle 200 to a predefined speed and/or possibly allowing onward travel for a maximum time period of, for example, y1 min, y2 min, or y3 min, and/or allowing onward travel for a maximum distance of, for example, z1 km, z2 km, or z3 km. If a safety measure is taken after the first fault F1, a second fault F1 does not necessarily have to occur for the tertiary braking system 106 to be utilized. For example, if the safety measure permits onward travel only for another z1 km, it is possible, after z1 km, to decelerate the motor vehicle 200 to a halt using the secondary braking system 106. The control unit 116 can trigger this measure.

Such a safety measure can be determined based on the comparison between the evaluated achievable deceleration potential and the defined safety criterion.

After a first fault F1, it is alternatively possible for the control unit 116 to stipulate a maximum permitted speed. If a second fault F2 occurs, the motor vehicle 200 must not continue to drive and must be brought to a halt for safety reasons. This preferably takes place by means of a moderate deceleration of the motor vehicle 200 that is pleasant for the motor vehicle passengers.

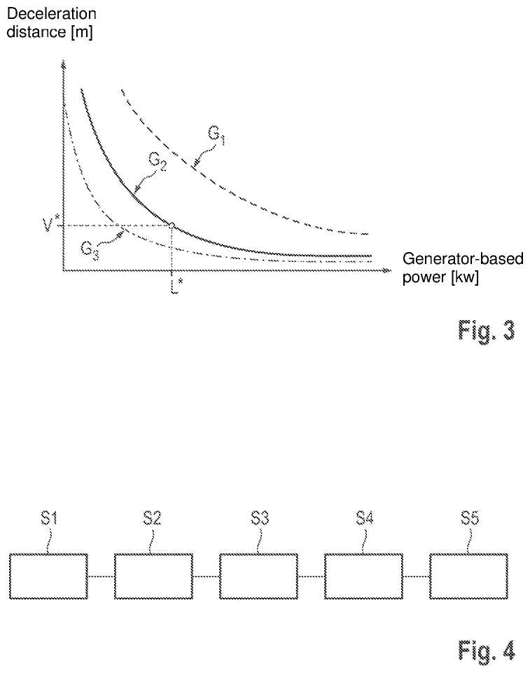

FIG. 3 shows an exemplary assessment of the deceleration potential. A deceleration distance in [m] is shown on the vertical axis. The generator-based power in [kW] is shown on the horizontal axis. The generator-based power can correspond to the braking power of the tertiary braking system 106 or correlate therewith. The generator-based power can correlate with the energy availability of the battery of the motor vehicle 200. For a power L*, a deceleration distance of V* can be achieved. The three curves G1 to G3 show speed isolines. The curve G1 can, for example, correspond to a constant vehicle speed of 80 km/h, the curve G2 can, for example, correspond to a constant vehicle speed of 100 km/h, and the curve G4 can, for example, correspond to a constant vehicle speed of 130 km/h.

FIG. 4 shows a flow chart of a method for operating a safety system 100 according to one exemplary embodiment. In a first step S1, an operating error of the primary braking system 102 is recognized by a monitoring device 108 of the safety system 100. In a second step S2, motor vehicle data, in particular data including driving surroundings information and/or motor vehicle state information, are detected by a detection unit of the safety system 100. In a further third step S3, the achievable deceleration potential of the tertiary braking system 106 of the motor vehicle 200 is evaluated, using motor vehicle data, by an evaluation unit of the safety system 100. The evaluated deceleration potential is compared in a fourth step S4 to a safety criterion by a comparison unit of the safety system 100. Finally. the electrically drivable motor vehicle 200 is controlled in a further step SS, particularly the secondary braking system 104 and/or the tertiary braking system 106, via the control unit 116. Step SS includes triggering a first safety measure.

In addition, it shall be pointed out that the terms “comprising” and “including” do not exclude other components and that the indefinite article “a” or “an” does not exclude the plural form. It shall furthermore be noted that features and steps described with reference to one of the above exemplary embodiments can also be used in combination with other features and steps of other exemplary embodiments described above. Reference numerals in the claims shall not be interpreted to have a limiting effect.

### LIST OF REFERENCE SIGNS

100 safety system
102 primary braking system
104 secondary braking system
106 tertiary braking system
108 monitoring device
110 detection unit
112 evaluation unit
114 comparison unit
116 control unit
118 interface
200 motor vehicle
202 energy storage device
204 motor vehicle drive
300 driving behavior
302 undisturbed driving behavior
304 controlled driving behavior
Z0 normal operation
Z1 first fallback level
Z2 second fallback level
F1 first fault
F2 second fault
G1, G2, G3 speed isoline
V* maximum deceleration distance
L* minimum generator-based power

1-12. (canceled)

13. A safety system for an electrically drivable motor vehicle, the safety system comprising:
a primary braking system;
a secondary braking system;
a tertiary braking system;
a monitoring device configured to recognize an operating error in the primary braking system and/or the secondary braking system;
a detection unit configured to detect motor vehicle data;
an evaluation unit configured to evaluate an achievable deceleration potential of the tertiary braking system using the motor vehicle data;
a comparison unit configured to compare the evaluated deceleration potential of the tertiary braking system to at least one defined safety criterion; and
a control unit configured to control the electrically drivable motor vehicle based on the recognition of the operating error and/or the comparison between the evaluated deceleration potential and the defined safety criterion.

14. The safety system of claim 13, wherein the control unit is further configured to control the secondary braking system and/or the tertiary braking system based on the recognition of the operating error and/or the comparison between the evaluated deceleration potential and the defined safety criterion.

15. The safety system of claim 13, wherein the detection unit is further configured to detect or receive driving surroundings information, and the motor vehicle data includes the driving surroundings information.

16. The safety system of claim 13, wherein the detection unit is further configured to detect or receive motor vehicle state information, and the motor vehicle data includes the motor vehicle state information.

17. The safety system of claim 13, wherein the control unit is further configured to control the secondary braking system and/or the tertiary braking system in such a way that a deceleration of the motor vehicle, a maximum permitted motor vehicle speed, a deceleration time for bringing the motor vehicle to a halt, or a remaining driving time of the motor vehicle is triggered.

18. The safety system of claim 13, wherein the tertiary braking system is configured to function as an electric motor braking system.

19. The safety system of claim 18, wherein the tertiary braking system is further configured to operate as a generator braking system.

20. A method for operating a safety system for an electrically drivable motor vehicle, the safety system including a primary braking system, a secondary braking system, a tertiary braking system, a monitoring device, a detection unit, an evaluation unit, a comparison unit, and a control unit, the method comprising:
recognizing, by the monitoring device, an operating error in the primary braking system;
detecting, by the detection unit, motor vehicle data, wherein the motor vehicle data includes driving surroundings information and/or motor vehicle state information;
evaluating, by the evaluation unit, an achievable deceleration potential of the tertiary braking system using the motor vehicle data;
comparing, by the comparison unit, the evaluated deceleration potential to at least one defined safety criterion; and
controlling, by the control unit, the electrically drivable motor vehicle based on the recognition of the operating error and/or the comparison between the evaluated deceleration potential and the defined safety criterion, wherein the control includes triggering a first safety measure.

21. The method of claim 20, further comprising:
recognizing, by the monitoring device, an operating error in the secondary braking system; and
controlling, by the control unit, the tertiary braking system, wherein the control comprises triggering a second safety measure.

22. The method of claim 20, wherein the first safety measure comprises a deceleration of the motor vehicle.

23. The method of claim 21, wherein the second safety measure comprises a full deceleration of the motor vehicle.

24. The method of claim 20, wherein the motor vehicle data detected by the detection unit comprises at least one of:
(a) vehicle mass;
(b) vehicle speed;
(c) tire temperature;
(d) battery state of charge; and
(e) road grade.

25. The method of claim 20, wherein controlling the electrically drivable motor vehicle further comprises:
controlling the secondary braking system and/or the tertiary braking system to achieve at least one of the following:
(a) a defined maximum permitted speed of the motor vehicle;
(b) a deceleration time for bringing the motor vehicle to a halt; and
(c) a remaining driving time of the motor vehicle.

26. The method of claim 20, wherein evaluating the achievable deceleration potential of the tertiary braking system comprises:
determining a deceleration distance achievable by the tertiary braking system based on generator-based power.

27. The method of claim 20, wherein controlling the tertiary braking system includes operating the tertiary braking system as an electric motor braking system and/or as a generator braking system.

27. A computer program product stored on a non-transitory computer-readable medium, the computer program product comprising instructions that, when executed by a processing unit, cause the processing unit to:
recognize an operating error in a primary braking system of a safety system for an electrically drivable motor vehicle;
detect motor vehicle data, wherein the motor vehicle data includes driving surroundings information and/or motor vehicle state information;
evaluate an achievable deceleration potential of a tertiary braking system using the motor vehicle data;
compare the evaluated deceleration potential of the tertiary braking system to at least one defined safety criterion; and
control the electrically drivable motor vehicle based on the recognition of the operating error and/or the comparison between the evaluated deceleration potential and the defined safety criterion, wherein the control includes triggering a first safety measure.

29. The computer program product of claim 28, wherein the instructions further cause the processing unit to:
recognize an operating error in a secondary braking system; and
control the tertiary braking system, wherein the control includes triggering a second safety measure.

30. The computer program product of claim 29, wherein the instructions further cause the processing unit to implement the second safety measure as a full deceleration of the motor vehicle.

31. The computer program product of claim 28, wherein the instructions further cause the processing unit to:
control a secondary braking system and/or the tertiary braking system to achieve at least one of the following:
(a) a defined maximum permitted speed of the motor vehicle;
(b) a deceleration time for bringing the motor vehicle to a halt; and
(c) a remaining driving time of the motor vehicle.

32. The computer program product of claim 28, wherein the instructions further cause the processing unit to control the tertiary braking system by operating it as an electric motor braking system and/or as a generator braking system.
